(19) United States
(12) Patent Application Publication
(10) Pub. No.: US 2020/0012112 A1
(43) Pub. Date: Jan. 9, 2020

(54) Multiple-Degree of Freedom Adjustable Discrete Type Near-Eye Display Device

(71) Applicant: Tsai-Hsien YANG, Taoyuan City (TW)

(72) Inventor: Tsai-Hsien YANG, Taoyuan City (TW)

(21) Appl. No.: 16/027,412

(22) Filed: Jul. 5, 2018

(51) Int. Cl. G02B 27/01; G06F 1/16

(52) U.S. Cl. CPC G02B 27/0176; G02B 2027/0159; G06F 1/1639; G06F 1/163

(57) ABSTRACT

The present invention relates to a near-eye display device. The near-eye display device includes a sensor assembly including a plurality of electronic sensors, each of which the plurality of electronic sensors are electrically connected with a central processing unit; an attaching unit configured on the sensor assembly to cause the sensor assembly detachably attached to a head of a user; a near-eye display module separated from the sensor assembly, electrically connected with the central processing unit, and showing an information for the user to see; and a connection and position adjustment module connecting the near-eye display module and the sensor assembly and allowing a position of the near-eye display module with respect to the sensor assembly to be adjusted by the user.

### FIELD

The present invention relates to a discrete type near-eye display device. In particular, it relates to a discrete type near-eye display device, which allows the near-eye display included in the near-eye display device to have a simply adjustable position with respect to a user's head in multiple-degree of freedom.

### BACKGROUND

In the state of the art, a near-eye display device, also known as, a near-to-eye display device, is a type of novel wearable device that provides a display right in front of a user's eyes and the user's line of sight, to show various digital contents in forms of, such as, images, graphics, texts, videos, audios, received and sent from, such as, a main board module, electronic sensors, a smart phone, a tablet or a notebook computer, on the display for the user to see. In general the near-eye display device is used to be an output interface for the main board module, the electronic sensors, the smart phone, the tablet or the notebook computer.

The display utilized in a near-eye display device may be transparent or opaque, and accordingly the device is generally categorized into two major types, which the first major type is a transparent or semi-transparent type near-eye display device, as known as, a see-through type near-eye display device, while the second major type is an opaque type near-eye display device. For an opaque type near-eye display device, an opaque display is utilized in the near-eye display device and shows digital contents to a user. The opaque-type device can use the conventional liquid crystal based panel as the opaque display and is much easier to create an immersive theater-like visual experiences for the user, as compared with the transparent type near-eye display device. The opaque-type near-eye display device is often applied as a tool and technology to realize and implement a virtual reality (VR).

As to a transparent or semi-transparent type near-eye display device, a see-through display is used in the device, which the see-through display allows a user to see the surrounding in the reality world through a see-through display while in the meantime the digital contents shows on the transparent display. The user can clearly see the real world and the digital contents in the meantime through the transparent or see-through display. The transparent type near-eye display device is often applied as a tool and technology to realize and implement an augmented reality (AR). Visually the reality world appears to act as a background for the see-through display while the transparent display shows digital contents, which is so cool and fascinating. Nowadays there are many kinds of see-through display based product available on the market, such as, the Microsoft HoloLens product, and the Epson Moverio BT-300 smart glass product. Although these products are able to provide astonishing and amazing visual experiences for users, these products inevitably have multiple significant shortages and deficiencies as follows.

Typically the designs of these products are focused on building and putting all kinds of electronic module and components together into a product based on one-single piece, which significantly causes the products gaining too much extra weight, and relatively large size. Therefore these products are actually too big to wear on a user's head. Actually a head wearable product with large size might look so strangle and possibly draws many unnecessary attentions when wearing on a user' head. What is even more important is when a user wears these products on the head, for example, the user certainly feels clumsy and uncomfortable and looks weird, due to the improper load distribution and the concentrated weight on the product, and its strangle funny appearance. Nevertheless, an additional significant deficiency for these products is that positions of these products with respect to the user's head are hardly adjusted.

There is a need to solve the above deficiencies/issues.

### SUMMARY

Accordingly, the present invention provides a near-eye display device. The near-eye display device includes a sensor assembly including a plurality of electronic sensors, each of which the plurality of electronic sensors are electrically connected with a central processing unit; an attaching unit configured on the sensor assembly to cause the sensor assembly detachably attached to a head of a user; a near-eye display module separated from the sensor assembly, electrically connected with the central processing unit, and showing an information for the user to see; and a connection and position adjustment module connecting the near-eye display module and the sensor assembly and allowing a position of the near-eye display module with respect to the sensor assembly to be adjusted by the user.

Preferably, the near-eye display device further includes one of following components: a main board module including the central processing unit, separated from and electrically connected with the sensor assembly, and the near-eye display module; a pair of earphones separated from and electrically connected with the main board module; and a battery module separated from, electrically connected with, and provides electrical power for the sensor assembly, the near-eye display module, the pair of earphones and the main board module.

Preferably, the near-eye display device further includes a nose pad having a first tip and a second tip, which the first tip is mounted on the sensor assembly and the second tip is placed on the user's nose, so as to provide a support for the sensor assembly.

Preferably, the plurality of electronic sensors are selected from a group consisting of an image sensor, a voice sensor, a camera lens, a gyroscope sensor, an accelerometer, a magnetometer, a barometer, an altimeter, a barometric altimeter, a light sensor, a motion sensor, a temperature sensor, an electronic compass, an infrared sensor and a combination thereof.

Preferably, the near-eye display module further includes a see-through display, which is one of a transparent based display and a semi-transparent based display.

Preferably, the connection and position adjustment module further includes a connection arm which has a first end and a second end at which the first and second ends a first pivot joint and a second pivot joint are disposed respectively.

Preferably, the connection and position adjustment module provides for a user to adjust a position of the near-eye display module with respect to the user's head.

Preferably, the connection and position adjustment module enables the near-eye display module to move a position with respect to the user's head to one of a upward direction, a downward direction, a leftward direction, a rightward direction, a forward direction and a backward direction.

Preferably, the connection and position adjustment module enables the near-eye display module to tilt to the right or the left with respect to the user's head.

Preferably, the connection and position adjustment module enables the near-eye display module to flip up or flip down.

### DESCRIPTION OF THE DRAWINGS

A more complete appreciation of the invention and many of the attendant advantages thereof are readily obtained as the same become better understood by reference to the following detailed description when considered in connection with the accompanying drawing, wherein:

FIG. 1 shows a schematic diagram illustrating the near-eye display device in accordance with the present invention;

FIG. 2(a) is a front view schematic diagram for first embodiment depicting the near-eye display device in use and worn by a user in accordance with the present invention;

FIG. 2(b) is a side view schematic diagram for first embodiment depicting the near-eye display device in use and worn by a user in accordance with the present invention;

FIG. 2(c) is a top view schematic diagram for first embodiment depicting the near-eye display device in use and worn by a user in accordance with the present invention;

FIG. 3(a) is a top view schematic diagram for second embodiment depicting the near-eye display device in use and worn by a user in accordance with the present invention;

FIG. 3(b) is a front view schematic diagram for second embodiment depicting the near-eye display device in use and worn by a user in accordance with the present invention;

FIG. 3(c) is a right-hand side view schematic diagram for second embodiment depicting the near-eye display device in use and worn by a user in accordance with the present invention;

FIG. 4 is a schematic diagram illustrating an elastic cord having a double holes stopper used in the present invention;

FIG. 5(a) is a schematic diagram illustrating the back of head of user wearing the near-eye display device using a cord with a pig nose stopper on the head in accordance with the present invention while the cord is tighten up by the pig nose stopper;

FIG. 5(b) is a schematic diagram illustrating the back of head of user wearing the near-eye display device using a cord with a pig nose stopper on the head in accordance with the present invention while the pig nose stopper is untighten;

FIG. 5(c) is a schematic diagram illustrating the back of head of user wearing the near-eye display device using a cord with a pig nose stopper on the head in accordance with the present invention while the pig nose stopper is untighten and the cord is loosen and hanging down around the neck of user;

FIG. 6(a) is a schematic diagram illustrating the back of head of user wearing the near-eye display device using a cord with double soft magnetic strips as stopper on the head in accordance with the present invention while the cord is tighten up by the magnetic strips;

FIG. 6(b) is a schematic diagram illustrating the back of head of user wearing the near-eye display device using a cord with double soft magnetic strips as stopper on the head in accordance with the present invention while the magnetic strips are detached from each other;

FIG. 6(c) is a schematic diagram illustrating the back of head of user wearing the near-eye display device using a cord with double soft magnetic strips as stopper on the head in accordance with the present invention while the magnetic strips are detached from each other and the cord is loosen and hanging down around the neck of user;

FIG. 7(a) is a front view schematic diagram depicting a up-down position tuning and a left-right position tuning of a position tuning mechanism provided by the connection and position adjustment module for the near-eye display device in accordance with the present invention worn by a user in the second embodiment;

FIG. 7(b) is a front view schematic diagram depicting a left-tilt position tuning of a position tuning mechanism provided by the connection and position adjustment module for the near-eye display device in accordance with the present invention worn by a user in the second embodiment;

FIG. 7(c) is a front view schematic diagram depicting a right-tilt position tuning of a position tuning mechanism provided by the connection and position adjustment module for the near-eye display device in accordance with the present invention worn by a user in the second embodiment;

FIG. 8(a) is a side view schematic diagram depicting a forward position tuning of a position tuning mechanism provided by the connection and position adjustment module for the near-eye display device in accordance with the present invention worn by a user in the second embodiment;

FIG. 8(b) is a side view schematic diagram depicting a backward position tuning of a position tuning mechanism provided by the connection and position adjustment module for the near-eye display device in accordance with the present invention worn by a user in the second embodiment;

FIG. 9(a) is a side view schematic diagram depicting a flip-up position of a position tuning mechanism provided by the connection and position adjustment module for the near-eye display device in accordance with the present invention worn by a user in the second embodiment;

FIG. 9(b) is a front view schematic diagram depicting a flip-down position of a position tuning mechanism provided by the connection and position adjustment module for the near-eye display device in accordance with the present invention worn by a user in the second embodiment;

FIG. 10(a) is a front view schematic diagram illustrating the front side of user wearing the near-eye display device using a cord which is loosen and hanging down around the neck of user in accordance with the present invention;

FIG. 10(b) is a side view schematic diagram illustrating the front side of user wearing the near-eye display device using a cord which is loosen and hanging down around the neck of user in accordance with the present invention;

FIG. 11(a) is a top view schematic diagram depicting the near-eye display device in use and worn by a user which the near-eye display device has a pair of earphone configured on the attaching unit in accordance with the present invention;

FIG. 11(b) is a front view schematic diagram depicting the near-eye display device in use and worn by a user which the near-eye display device has a pair of earphone configured on the attaching unit in accordance with the present invention;

FIG. 11(c) is a right-hand side view schematic diagram depicting the near-eye display device in use and worn by a user which the near-eye display device has a pair of earphone configured on the attaching unit in accordance with the present invention;

FIG. 12(a) is a front view schematic diagram depicting the near-eye display device in use and worn by a user in accordance with the present invention which the near-eye display device has a nose pad configured on the sensor assembly for a user requiring to wear glasses;

FIG. 12(b) is a side view schematic diagram depicting the near-eye display device in use and worn by a user in accordance with the present invention which the near-eye display device has a nose pad configured on the sensor assembly for a user requiring to wear glasses; and

FIG. 12(c) is a side view schematic diagram depicting the near-eye display device in use and worn by a user wearing the glasses in accordance with the present invention which the near-eye display device has a nose pad configured on the sensor assembly.

### DETAILED DESCRIPTION

The present disclosure will be described with respect to particular embodiments and with reference to certain drawings, but the disclosure is not limited thereto but is only limited by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice.

The present disclosure will now be described by a detailed description of several embodiments. It is clear that other embodiments can be configured according to the knowledge of persons skilled in the art without departing from the true technical teaching of the present disclosure, the claimed disclosure being limited only by the terms of the appended claims.

It is to be noticed that the term “comprising” or “including”, used in the claims and specification, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device including means A and B” should not be limited to devices consisting only of components A and B. The tern “discrete type” used in the claims and specification is referred to as “split type” or “separated type” as well and equivalently.

A part of the present disclosure is based on and partly uses technologies disclosed in both U.S. utility Pat. No. 9,678,349 B2 and U.S. utility patent application Ser. No. 15/676,001, which was allowed by USPTO. The above US utility patent and application have the Applicant the same as this application does and are incorporated into this application by reference as if fully set forth herein.

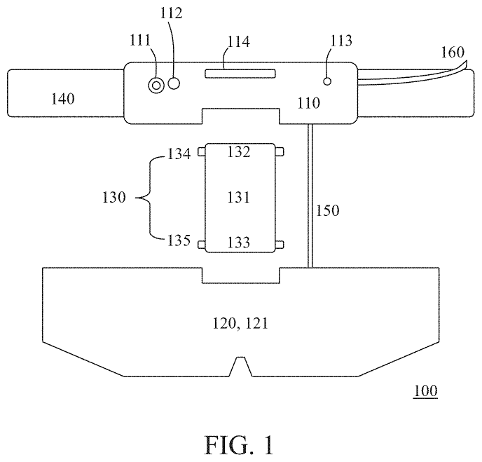

FIG. 1 shows a schematic diagram illustrating the near-eye display device in accordance with the present invention. The present near-eye display device 100 includes a sensor assembly 110, a near-eye display module 120, a connection and position adjustment module 130, and an attaching unit 140. The sensor assembly 110 includes and integrates a variety of electronic sensors, such as, an image sensor, a voice sensor, a camera lens, a gyroscope sensor, an accelerometer, a magnetometer, a barometer, an altimeter, a barometric altimeter, a light sensor, a motion sensor, a temperature sensor, an electronic compass, or an infrared sensor. In this embodiment, a camera 111, a flash light 112, a micro phone 113, and a headlight 114 is additionally configured on the sensor assembly 110, and the sensor assembly 110 is electrically connected to a main board module and a battery module separated from the sensor assembly 110 through the transmission cable 160, preferably a charge and sync cable.

The near-eye display module 120 is preferably a transparent display, or a see-through display 121 that a user can still see the actual surrounding environment of reality world like a background appearing behind the digital contents shown on the see-through display 121 in the meantime while the user is wearing the near-eye display module 120 and seeing the static or the dynamic digital contents shown on the see-through display 121. The near-eye display module 120 preferably belongs to a kind of a head-mounted display (HMD) device. The near-eye display module 120 is electrically connected with the sensor assembly 110 through a flexible bus line 150, which is a group of electric wires used to transmit data or electronic signals, or through a transmission cable, preferably a charge and sync cable, between the sensor assembly 110 and the near-eye display module 120.

The connection and position adjustment module 130 includes, for example, a connection arm 131 which has a first end 132 and a second end 133 at which a first pivot joint 134 and a second pivot joint 135 are disposed respectively. The first pivot joint 134 on the first end 132 is used for connecting to the sensor assembly 110 and the second pivot joint 135 on the second end 133 is used for connecting to the near-eye display module 120. By the linkage of the connection and position adjustment module 130, the near-eye display module 120 is suspended on, but separated from the sensor assembly 110.

The attaching unit 140 is configured to the sensor assembly 110 to cause the sensor assembly module 110 capable of being detachably (separable, removable) attached to a user's head, in particular, a user's forehead. Typically the attaching unit 140 is a support and securing structure capable of detachably securing/attaching the sensor assembly 110, the near-eye display module 120 and the connection and position adjustment module 130, onto the user's head and capable of causing the see-through display 121 on the near-eye display module 120 appearing in the user's line of sight at an appropriate distance from the user's eyes. The attaching unit 140 is made of soft, flexible, or elastic materials and preferably a headband, a sweatband, a size band, an adjustable belt, an elastic support arm, a flexible support frame, a light support, a support temple or a silicon support.

Thus, the digital information can be presented to the near-eye display module 120 and then projected into the user's eyes. Preferably, since the see-through display 121 is transparent or semi-transparent, the information shown on the see-through display 121 is superimposed on the actual scene and the actual surrounding environment of reality world beyond the see-through display 121 and in front of the user.

Typically the connection arm 131, the first pivot joint 134, and the second pivot joint 135 jointly form and provide a multiple-degree of freedom based position adjustable mechanical structure for the near-eye display module 120 to adjust a position with respect to the sensor assembly 110. One of multiple embodiments for the connection and position adjustment module 130 is disclosed in U.S. Pat. No. 9,678,349 B2 which has the Applicant the same as the present invention does and is incorporated into this application by reference as if fully set forth herein. The near-eye display module 120 is disposed on the sensor assembly 110 through the connection and position adjustment module 130. Therefore, a user can easily flip up, or move the near-eye display module 120 to have a clear and unscreened field of eyesight or well focused displayed information.

The electronic modules including the sensor assembly 110 and the near-eye display module 120, are electrically connected to a central processing unit on a main board module which is separated from the sensor assembly 110 and the near-eye display module 120, and a battery module which is separated from the sensor assembly 110, the near-eye display module 120, and the main board module. The sensor assembly 110, the near-eye display module 120, the main board module, the main board module and the battery module are separated from each other but electrically connected with each other. The central processing unit, the main board module and the battery module are deployed and well hidden on a clothing accessory worn on a user, as disclosed in the allowed U.S. patent application Ser. No. 15/676,001 which has the Applicant the same as the present invention does and is incorporated into this application by reference as if fully set forth herein.

The main board module includes the central processing unit (CPU), a memory module, a wireless communication module, a USB interface, a HDMI interface, a NFC interface, a uSIM slot, a uSD card slot, an ear phone socket, a signal line socket and a power line socket. The main board module mainly acts as a processing unit responsible for receiving data for processing and computing. The near-eye display module 120 is electrically connected with the main board module through one of a wire based connection or a wireless connection scheme. In this embodiment, the near-eye display module 120 is electrically connected to the main board module through a transmission cable 160, preferably a charge and sync cable. The near-eye display module 120 mainly acts as an output unit for users and is designed to have the cool look of a sunglass.

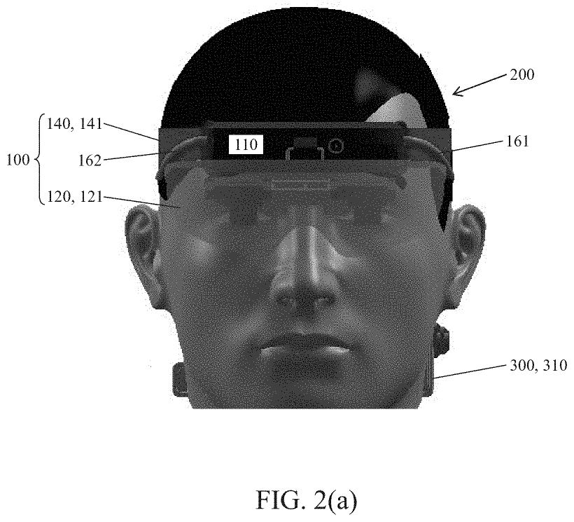

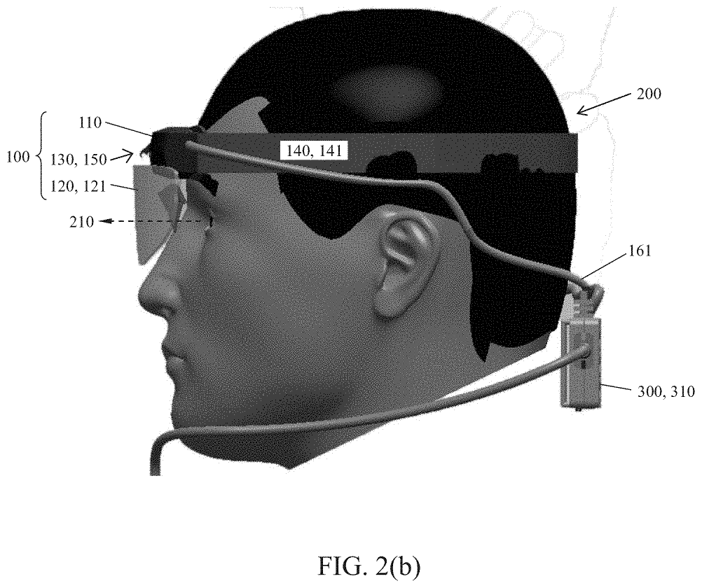

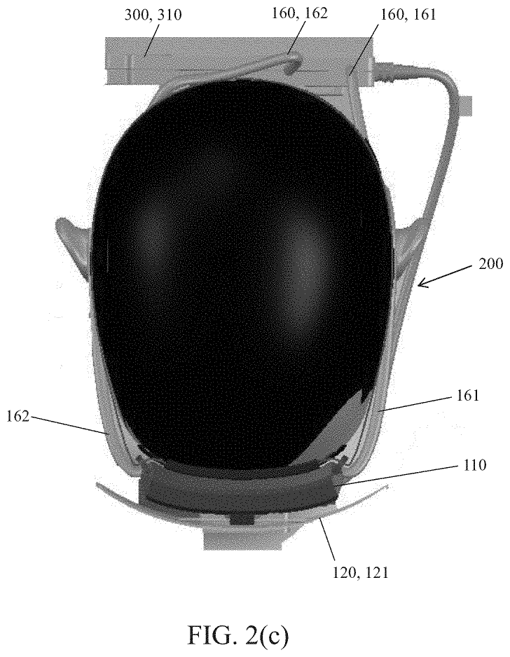

FIG. 2(a) is a front view schematic diagram for first embodiment in accordance with the present invention depicting the near-eye display device in use and worn by a user; FIG. 2(b) is a side view schematic diagram for first embodiment in accordance with the present invention depicting the near-eye display device in use and worn by a user; FIG. 2(c) is a top view schematic diagram for first embodiment in accordance with the present invention depicting the near-eye display device in use and worn by a user. The near-eye display device 100 in accordance with the present invention is used to be worn onto a user's head 200, in particular, attached to a user's forehead by the attaching unit 140.

In this embodiment, as shown in FIGS. 2(a) and 2(b), an elastic headband 141 acting as the attaching unit 140 is coupled to the sensor assembly 110 such that the near-eye display device 100 is correctly worn by a user and attached to the user's head 200, such that the see-through display 121 is placed in the user's line of sight 210 correctly. The see-through display 121 is preferably a plate of semi-transparent or a transparent liquid crystal display. The user still can see the actual scene, the surrounding environment (reality world), through the see-through display 121.

As shown in FIGS. 2(b) and 2(c), a main board module 300 or a battery module 310 is preferably placed behind the user's head 200 and separated from the sensor assembly 110 and the see-through display 121. A transmission cable 160, preferably a charge and sync cable, including a right-hand side transmission cable 161 and a left-hand side transmission cable 162 are electrically connecting the main board module 300 and the sensor assembly 110. Preferably, the information shown on the see-through display 121 is to be superimposed on the actual scene beyond the see-through display 121 and in front of the user. The see-through display 121 is electrically connected with the sensor assembly 110 through the flexible bus line 150 which is integrated into and hidden inside the connection and position adjustment module 130 in this embodiment.

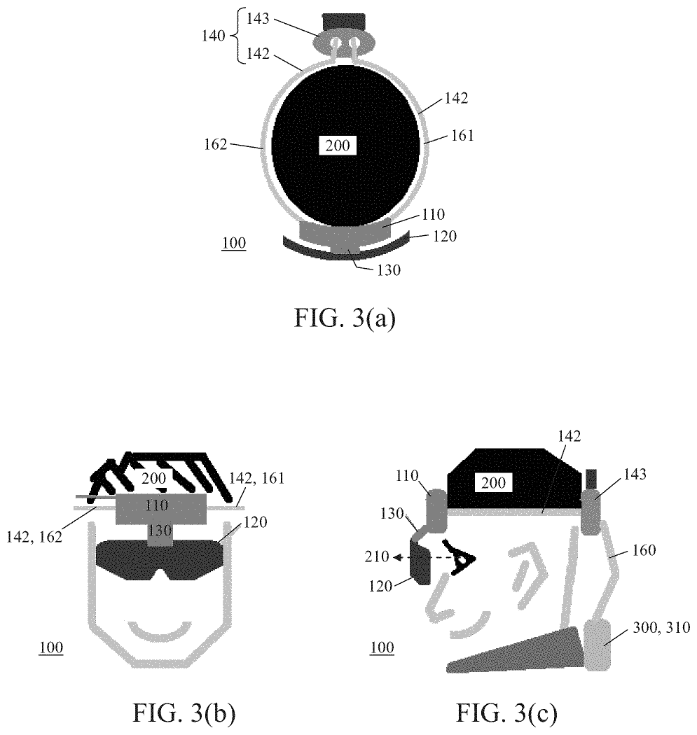

FIG. 3(a) is a top view schematic diagram for second embodiment in accordance with the present invention depicting the near-eye display device in use and worn by a user; FIG. 3(b) is a front view schematic diagram for second embodiment in accordance with the present invention depicting the near-eye display device in use and worn by a user; FIG. 3(c) is a right-hand side view schematic diagram for second embodiment in accordance with the present invention depicting the near-eye display device in use and worn by a user.

In this embodiment, an elastic fabric cord 142 with a pig nose stopper 143 acts as the attaching unit 140 and is coupled to the sensor assembly 110, such that the near-eye display device 100 is correctly worn and attached to a user's head 200, and the see-through display 121 is correctly placed in the user's line of sight 210. The see-through display 121 is typically a plate of semi-transparent or a transparent liquid crystal display. The user still can see the actual scene, the surrounding environment (reality world), through the see-through display 121. Preferably, the information shown on the see-through display 121 is to be superimposed on the actual scene beyond the see-through display 121 and to be shown in front of the user.

A main board module 300 is placed behind the user's head 200 and separated from the sensor assembly 110 and the see-through display 121. A transmission cable for electrically connecting the main board module 300 or the battery module 310 and the sensor assembly 110 including a right-hand side and left-hand side transmission cables 161, 162 can be built into the elastic fabric cord 142.

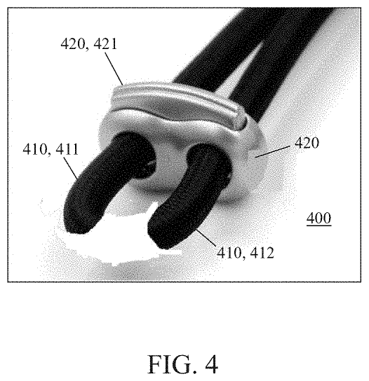

FIG. 4 is a schematic diagram illustrating an elastic cord having a double holes stopper used in the present invention. The elastic cord 400 preferably includes a segment of an elastic fabric cord 410 has two ends 411 and 412 which the two ends 411, 412 are closed together and fastened by a double holes (pig nose) stopper 420. A stopper can be a cord lock, a cord stopper, or a fastener, and the stopper has double holes is also nicknamed as a pig nose stopper. The double holes stopper 420 has a spring loaded button 421, which ensures a tight and secure close for two ends 411, 412 of the elastic fabric cord 410, to prevent loosen or unwanted slipping.

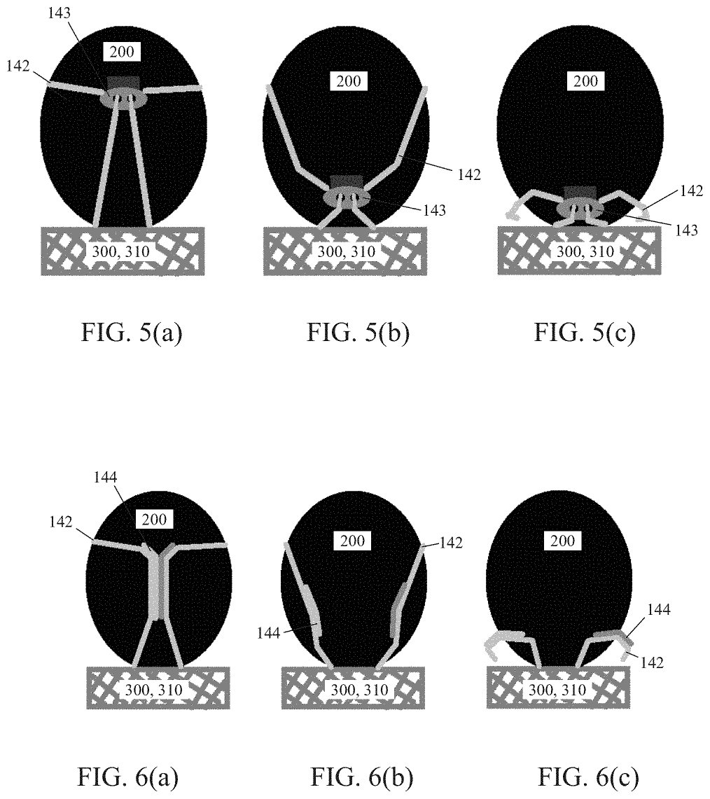

FIG. 5(a) is a schematic diagram illustrating the back of head of user wearing the near-eye display device using a cord with a pig nose stopper on the head in accordance with the present invention while the cord is tighten up by the pig nose stopper; FIG. 5(b) is a schematic diagram illustrating the back of head of user wearing the near-eye display device using a cord with a pig nose stopper on the head in accordance with the present invention while the cord is untighten from the pig nose stopper; FIG. 5(c) is a schematic diagram illustrating the back of head of user wearing the near-eye display device using a cord with a pig nose stopper on the head in accordance with the present invention while the cord is loosen and hanging down around the neck of user.

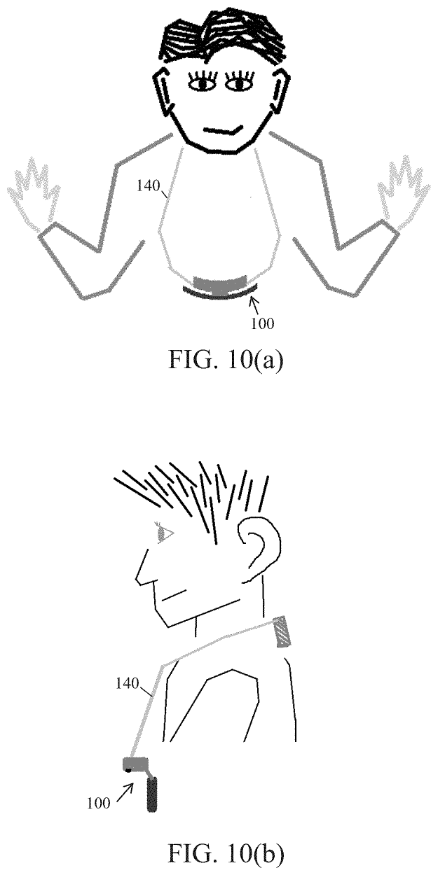

In this embodiment, as show in FIGS. 5(a)-5(c), a user wears the near-eye display device 100 on the head 200 which the near-eye display device 100 uses an elastic fabric cord 142 having a pig nose stopper 143 on the elastic fabric cord 142. A main board module 300 or a battery module 310 is separated from the near-eye display module 120. While the elastic fabric cord 142 is tighten up by the pig nose stopper 143, the near-eye display device 100 is well secured on the user's head 200 as shown in FIG. 5(a). While the elastic fabric cord 142 is untighten from the pig nose stopper 143 as shown in FIG. 5(b), the near-eye display device is correspondingly loosen and hanging down around the user's neck as shown in FIG. 5(c), as well as shown in FIGS. 10(a) and 10(b).

FIG. 6(a) is a schematic diagram illustrating the back of head of user wearing the near-eye display device using a cord with double soft magnetic strips as stopper on the head in accordance with the present invention while the cord is tighten up by the magnetic strips; FIG. 6(b) is a schematic diagram illustrating the back of head of user wearing the near-eye display device using a cord with double soft magnetic strips as stopper on the head in accordance with the present invention while the cord is untighten from the magnetic strips; FIG. 6(c) is a schematic diagram illustrating the back of head of user wearing the near-eye display device using a cord with double soft magnetic strips as stopper on the head in accordance with the present invention while the cord is loosen and hanging down around the neck of user.

In some embodiments, the pig nose stopper can be replaced by the soft magnetic strip. As shown in FIGS. 6(a)-6(c), a user wears the near-eye display device 100 on the head 200 which the near-eye display device 100 uses an elastic fabric cord 142 having double magnetic strips 144 as the stopper. A main board module 300 or a battery module 310 is separated from the near-eye display module 120. While the double magnetic strips 144 are attracted by each other, the elastic fabric cord 142 is therefore tighten up by the double magnetic strips 144, and the near-eye display device is well secured on the user's head 200 as shown in FIG. 6(a). While the double magnetic strips 144 are separated from each other, the elastic fabric cord 142 is untighten as shown in FIG. 6(b), and the near-eye display device is correspondingly loosen and hanging down around the user's neck as shown in FIG. 6(c), as well as shown in FIGS. 10(a) and 10(b).

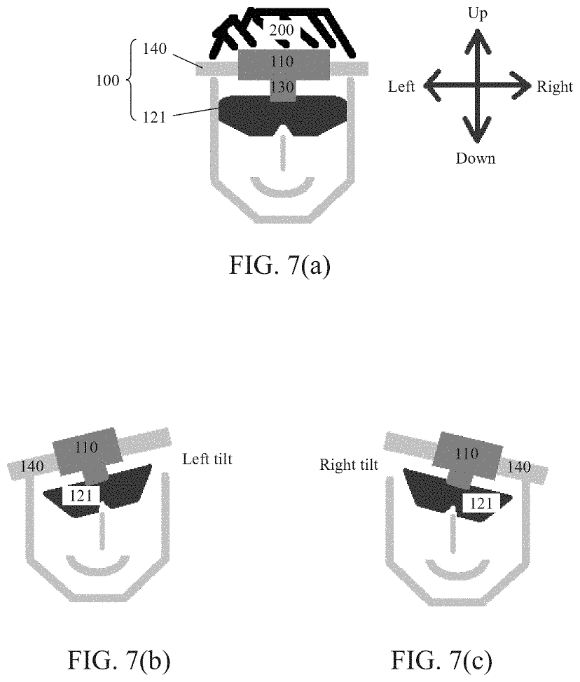

FIG. 7(a) is a front view schematic diagram depicting a up-down position tuning and a left-right position tuning of a position tuning mechanism for the near-eye display device in accordance with the present invention worn by a user; FIG. 7(b) is a front view schematic diagram depicting a left-tilt position tuning of a position tuning mechanism for the near-eye display device in accordance with the present invention worn by a user; FIG. 7(c) is a front view schematic diagram depicting a right-tilt position tuning of a position tuning mechanism for the near-eye display device in accordance with the present invention worn by a user.

The present invention proposes to spilt or separate off some electronic components, such as, the main board and battery, from the head-worn part or the head-mounted part, namely the near-eye display device 100, trying to significantly reduce the total weight for the entire near-eye display device 100, such that a user can wear the near-eye display device 100 more comfortably. The present invention further proposes to split and separate all sensors off from the near-eye display module 120 to integrate as the sensor assembly 110 independently, and uses the connection and position adjustment module 130 to connecting the near-eye display module 120 and the sensor assembly 110. The structure as above proposed by the present invention enables the see-through display 121 to have more degree of freedom for a position or posture adjustment to adjust a position with respect to the sensor assembly 110 or a user's head 200 on multiple and different dimensions.

As shown in FIG. 7(a), the attaching unit 140 in the present invention is mainly made of soft, flexible, or elastic materials and the near-eye display device 100 is worn onto a user's head 200 through the attaching unit 140. Therefore a user is able to move a position of the see-through display 121 in relative to the sensor assembly 110 to go up, down, left or right, through straightforwardly adjusting the attaching unit 140, such as a headband or an elastic cord, simply by hands. As shown in FIGS. 7(b) and 7(c), a user is even able to slightly tilt the see-through display 121 to the right or the left through straightforwardly adjusting the attaching unit 140 simply by using hands as well.

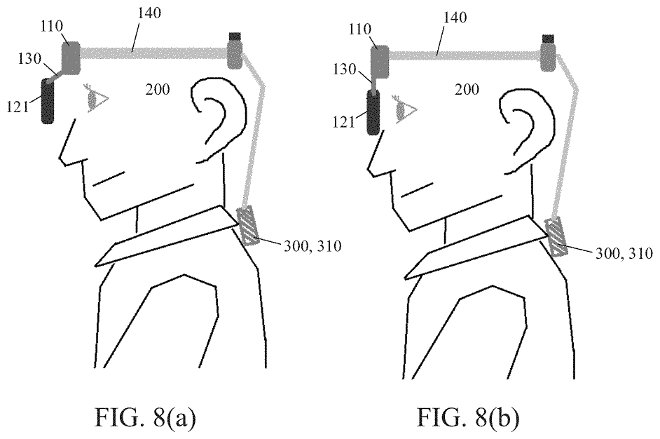

FIG. 8(a) is a side view schematic diagram depicting a forward position tuning of a position tuning mechanism for the near-eye display device in accordance with the present invention worn by a user; FIG. 8(b) is a side view schematic diagram depicting a backward position tuning of a position tuning mechanism for the near-eye display device in accordance with the present invention worn by a user.

As shown in FIG. 8(a), due to the cooperation of all components in the connection and adjustment module 130, including the connection arm 131, the first pivot joint 134 and the second pivot joint 135, a user is able to move a position of the see-through display 121 to go forward with respect to the sensor assembly 110, simply by moving the see-through display 121 slightly away from eyes by hands. On the contrary, as shown in FIG. 8(b), a user is able to move a position of the see-through display 121 to go backward with respect to the sensor assembly 110 or to return to the start-up position, simply by moving the see-through display 121 more close to eyes by hands.

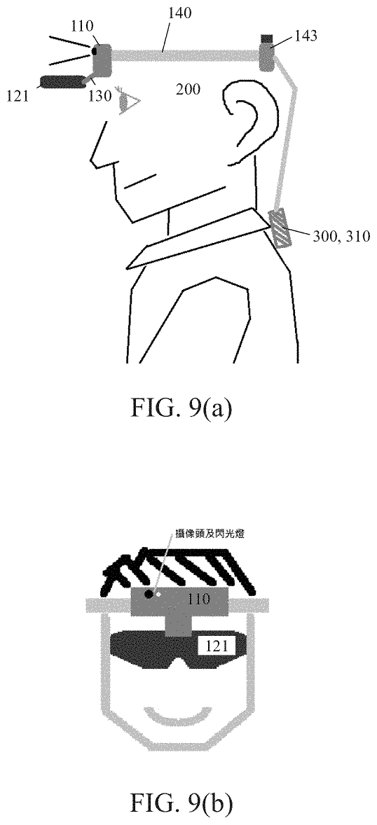

FIG. 9(a) is a side view schematic diagram depicting a flip-up position of a position tuning mechanism for the near-eye display device in accordance with the present invention worn by a user; FIG. 9(b) is a front view schematic diagram depicting a flip-down position of a position tuning mechanism for the near-eye display device in accordance with the present invention worn by a user.

As shown in FIGS. 9(a)-9(b), due to the cooperation of all components in the connection and adjustment module 130, a user is able to flip the see-through display 121 up from the original position, simply by hands, as well as, a user is able to flip down the see-through display 121 to the original position, simply by hands. No matter when the see-through display 121 is currently flipped up or down, all the sensors built in the sensor assembly 110, in particular, the camera, the image sensor, the flash light 112 and the headlight, are able to keep operating without being blocked or interfered by the see-through display 121, as shown in FIGS. 9(a)-9(b).

FIG. 10(a) is a front view schematic diagram illustrating the front side of user wearing the near-eye display device using a cord and loosen and hanging down around the neck of user; FIG. 10(b) is a side view schematic diagram illustrating the front side of user wearing the near-eye display device using a cord and loosen and hanging down around the neck of user.

In this embodiment, as show in FIGS. 10(a) and 10(b), when the near-eye display device 100 is not in use, the attaching unit 140 is untightened, unlocked, or released and the near-eye display device 100 and the attaching unit 140 are naturally hanging down around the user's neck like a decorative necklace. Similarly when a user does not require using the near-eye display device 100, the user untightens, unlocks, or releases the attaching unit 140 and lets the near-eye display device 100 and the attaching unit 140 hanging down around the user's neck like a decorative necklace.

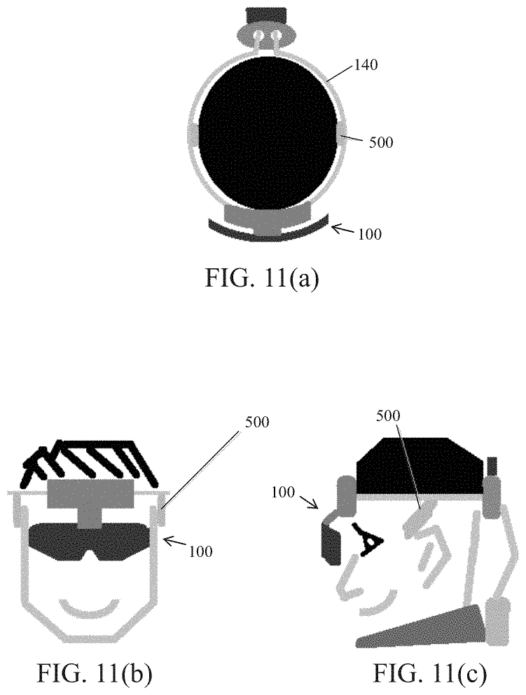

FIG. 11(a) is a top view schematic diagram depicting the near-eye display device in use and worn by a user which the near-eye display device has a pair of earphone configured on the attaching unit in accordance with the present invention; FIG. 11(b) is a front view schematic diagram depicting the near-eye display device in use and worn by a user which the near-eye display device has a pair of earphone configured on the attaching unit in accordance with the present invention; FIG. 11(c) is a right-hand side view schematic diagram depicting the near-eye display device in use and worn by a user which the near-eye display device has a pair of earphone configured on the attaching unit in accordance with the present invention.

As shown in FIGS. 11(a)-11(c), for the near-eye display device 100, when it is in use by a user, the attaching unit 140, for example, the cord, surrounds a user's forehead and must extend and pass by user's ears. Therefore a pair of earphones 500, in particular, a pair of bone conduction earphones, is basically designed to deploy on a position close to user's ears on the attaching unit 140.

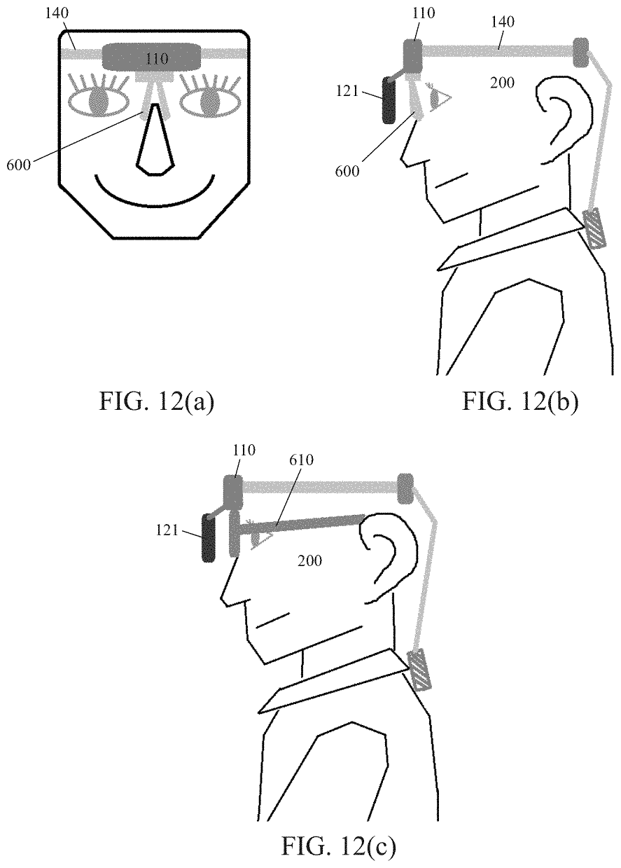

FIG. 12(a) is a front view schematic diagram depicting the near-eye display device in use and worn by a user in accordance with the present invention which the near-eye display device has a nose pad configured on the sensor assembly for a user requiring to wear glasses; FIG. 12(b) is a side view schematic diagram depicting the near-eye display device in use and worn by a user in accordance with the present invention which the near-eye display device has a nose pad configured on the sensor assembly for a user requiring to wear glasses; FIG. 12(c) is a side view schematic diagram depicting the near-eye display device in use and worn by a user wearing the glasses in accordance with the present invention which the near-eye display device has a nose pad configured on the sensor assembly.

As if a user is short-sighted and has to wear glasses 610 or spectacle, an additional optional accessory, a nose pad 600, is added to the near-eye display device 100. The nose pad 600 is preferably mounted at the bottom side of the sensor assembly 110, and able to provide more support for the sensor assembly 110 in addition to the attaching unit 140, so as to prevent the sensor assembly 110 from sliding downward gradually from user's head 200 and create more space for the vacancy for containing the glasses 610 available under the sensor assembly 110. Therefore, when a user requires wearing glasses 610, the nose pad 600 is able to support the sensor assembly 110 up to prevent the sensor assembly 110 from moving downward resulting in pushing the glasses 610 the user is wearing.

There are further embodiments provided as follows.

Embodiment 1: A near-eye display device includes a sensor assembly including a plurality of electronic sensors, each of which the plurality of electronic sensors are electrically connected with a central processing unit; an attaching unit configured on the sensor assembly to cause the sensor assembly detachably attached to a head of a user; a near-eye display module separated from the sensor assembly, electrically connected with the central processing unit, and showing an information for the user to see; and a connection and position adjustment module connecting the near-eye display module and the sensor assembly and allowing a position of the near-eye display module with respect to the sensor assembly to be adjusted by the user.

Embodiment 2: The near-eye display device as described in Embodiment 1 further includes one of following components: a main board module including the central processing unit, separated from and electrically connected with the sensor assembly, and the near-eye display module; a pair of earphones separated from and electrically connected with the main board module; and a battery module separated from, electrically connected with, and provides electrical power for the sensor assembly, the near-eye display module, the pair of earphones and the main board module.

Embodiment 3: The near-eye display device as described in Embodiment 1 further includes a nose pad having a first tip and a second tip, which the first tip is mounted on the sensor assembly and the second tip is placed on the user's nose, so as to provide a support for the sensor assembly.

Embodiment 4: The near-eye display device as described in Embodiment 1, the plurality of electronic sensors are selected from a group consisting of an image sensor, a voice sensor, a camera lens, a gyroscope sensor, an accelerometer, a magnetometer, a barometer, an altimeter, a barometric altimeter, a light sensor, a motion sensor, a temperature sensor, an electronic compass, an infrared sensor and a combination thereof.

Embodiment 5: The near-eye display device as described in Embodiment 1, the near-eye display module further includes a see-through display, which is one of a transparent based display and a semi-transparent based display.

Embodiment 6: The near-eye display device as described in Embodiment 1, the connection and position adjustment module further includes a connection arm which has a first end and a second end at which the first and second ends a first pivot joint and a second pivot joint are disposed respectively.

Embodiment 7: The near-eye display device as described in Embodiment 6, the first pivot joint on the first end is used for connecting to the sensor assembly and the second pivot joint on the second end is used for connecting to the near-eye display module.

Embodiment 8: The near-eye display device as described in Embodiment 1, the connection and position adjustment module provides the near-eye display module to secure on the sensor assembly.

Embodiment 9: The near-eye display device as described in Embodiment 1, the connection and position adjustment module provides for a user to adjust a position of the near-eye display module with respect to the user's head.

Embodiment 10: The near-eye display device as described in Embodiment 1, the connection and position adjustment module enables the near-eye display module to move a position with respect to the user's head to one of a upward direction, a downward direction, a leftward direction, a rightward direction, a forward direction and a backward direction.

Embodiment 11: The near-eye display device as described in Embodiment 1, the connection and position adjustment module enables the near-eye display module to tilt to the right or the left with respect to the user's head.

Embodiment 12: The near-eye display device as described in Embodiment 1, the connection and position adjustment module enables the near-eye display module to flip up or flip down.

Embodiment 13: The near-eye display device as described in Embodiment 1, the attaching unit is one selected from a headband, a sweatband, a size band, an adjustable belt, an elastic support arm, a flexible support frame, a light support, a support temple, and a silicon support.

Embodiment 14: The near-eye display device as described in Embodiment 1, the attaching unit further includes one of a stopper, a lock, a fastener, a range button, a spring loaded button, a magnetic strip, a magnet, a Velcro strap, a buckle, and a snap.

While the disclosure has been described in terms of what are presently considered to be the most practical and preferred embodiments, it is to be understood that the disclosure need not be limited to the disclosed embodiments. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present disclosure which is defined by the appended claims.

What is claimed is:

1. A near-eye display device, comprising:
a sensor assembly comprising a plurality of electronic sensors, each of which the plurality of electronic sensors are electrically connected with a central processing unit;
an attaching unit configured on the sensor assembly to cause the sensor assembly detachably attached to a head of a user;
a near-eye display module separated from the sensor assembly, electrically connected with the central processing unit, and showing an information for the user to see; and
a connection and position adjustment module connecting the near-eye display module and the sensor assembly and allowing a position of the near-eye display module with respect to the sensor assembly to be adjusted by the user.

2. The near-eye display device as claimed in claim 1, further comprising one of following components:
a main board module including the central processing unit, which the central processing unit is separated from and electrically connected with the sensor assembly, and the near-eye display module;
a pair of earphones separated from, electrically connected with the main board module, and configured on the attaching unit; and
a battery module separated from, electrically connected with, and provides electrical power for the sensor assembly, the near-eye display module, the pair of earphones and the main board module.

3. The near-eye display device as claimed in claim 1, further comprising:
a nose pad having a first tip and a second tip, which the first tip is mounted on the sensor assembly and the second tip is placed on the user's nose, so as to provide a support for the sensor assembly.

4. The near-eye display device as claimed in claim 1, wherein the plurality of electronic sensors are selected from a group consisting of an image sensor, a voice sensor, a camera lens, a gyroscope sensor, an accelerometer, a magnetometer, a barometer, an altimeter, a barometric altimeter, a light sensor, a charge-coupled sensor, a motion sensor, a temperature sensor, an electronic compass, an infrared sensor and a combination thereof.

5. The near-eye display device as claimed in claim 1, wherein the near-eye display module further comprises a see-through display, which is one of a transparent based display and a semi-transparent based display.

6. The near-eye display device as claimed in claim 1, wherein the connection and position adjustment module further comprises a connection arm which has a first end and a second end at which the first and second ends a first pivot joint and a second pivot joint are disposed respectively.

7. The near-eye display device as claimed in claim 6, wherein the first pivot joint on the first end is used for connecting to the sensor assembly and the second pivot joint on the second end is used for connecting to the near-eye display module.

8. The near-eye display device as claimed in claim 1, wherein the connection and position adjustment module is used to provide the near-eye display module to secure on the sensor assembly.

9. The near-eye display device as claimed in claim 1, wherein the connection and position adjustment module provides for a user to adjust a position of the near-eye display module with respect to the user's head.

10. The near-eye display device as claimed in claim 1, wherein the connection and position adjustment module enables the near-eye display module to move to a position with respect to the user's head to one of a upward direction, a downward direction, a leftward direction, a rightward direction, a forward direction and a backward direction.

11. The near-eye display device as claimed in claim 1, wherein the connection and position adjustment module enables the near-eye display module to tilt to the right or the left with respect to the user's head.

12. The near-eye display device as claimed in claim 1, wherein the connection and position adjustment module enables the near-eye display module to flip up or flip down based on the connection and position adjustment module as an original point.

13. The near-eye display device as claimed in claim 1, wherein the attaching unit is one selected from a headband, a sweatband, a size band, an adjustable belt, an elastic support arm, a flexible support frame, a light support, a temple, a spectacle frame and a silicon support, and a combination thereof.

14. The near-eye display device as claimed in claim 1, wherein the attaching unit further comprises one of a stopper, a cord lock, a fastener, a range button, an end stopper, a spring loaded button, a magnetic strip, a magnet, a Velcro strap, a hook and loop, a buckle, a snap, and a combination thereof.
